(19) United States
(12) Patent Application Publication
(10) Pub. No.: US 2024/0389103 A1
(43) Pub. Date: Nov. 21, 2024

(54) METHODS AND DEVICES FOR CONFIGURING AND SCHEDULING PHYSICAL UPLINK CONTROL CHANNEL

(71) Applicant: ZTE Corporation, Shenzhen (CN)

(72) Inventors: Wei GOU, Shenzhen (CN); Xianghui Han, Shenzhen (CN); Xingguang Wei, Shenzhen (CN); Shuaihua Kou, Shenzhen (CN)

(73) Assignee: ZTE Corporation, Shenzhen (CN)

(21) Appl. No.: 18/789,919

(22) Filed: Jul. 31, 2024

Related U.S. Application Data
(63) Continuation of application No. PCT/CN2022/109213, filed on Jul. 29, 2022.

(51) Int. Cl. H04W 72/21; H04L 5/00

(52) U.S. Cl. CPC H04W 72/21; H04L 5/0098; H04L 5/0005

(57) ABSTRACT

The present disclosure describes methods, system, and devices for configuring and scheduling a physical uplink control channel (PUCCH). A method includes transmitting, by a user equipment (UE), a PUCCH to a base station, the UE being configured with an uplink (UL) subband, by: receiving, by the UE, a configuration for at least one PUCCH resource; determining, by the UE, whether a PUCCH resource is valid for the UL subband based on the configuration; and in response to the determining that the PUCCH resource is valid for the UL subband, transmitting, by the UE, the PUCCH in the PUCCH resource to the base station.

### TECHNICAL FIELD

The present disclosure is directed generally to wireless communications. Particularly, the present disclosure relates to methods and devices for configuring and scheduling a physical uplink control channel (PUCCH).

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

In some existing wireless communication schemes, an uplink (UL) symbol or slot may be configured/scheduled to transmit data or control information from a user equipment to a base station; and a downlink (DL) symbol or slot may be configured/scheduled to transmit data or control information from the base station to the UE. In some existing schemes, UL symbols/slots are fewer and/or discontinuous in comparison to DL symbols/slots, resulting relatively poor performance in term of the timeliness and/or edge coverage of UL transmission, which may be due to no more consecutive UL symbols/slots. When a UL subband is configured in one or more DL symbol or slot and/or flexible symbol/slot, there are issues/problems associated with how to obtain physical uplink control channel (PUCCH) resources for PUCCH transmission for a UL subband.

The present disclosure describes various embodiments for configuring and scheduling a physical uplink control channel (PUCCH) in a UL subband, addressing at least one of the issues/problems discussed above, improving performance of the wireless communication, particularly the performance of PUCCH resource configuration and/or PUCCH transmission.

### SUMMARY

This document relates to methods, systems, and devices for wireless communication, and more specifically, for configuring and scheduling a physical uplink control channel (PUCCH), particularly for a UL subband. The various embodiments in the present disclosure may increase the resource utilization efficiency and boost latency performance of the wireless communication.

In one embodiment, the present disclosure describes a method for wireless communication. The method includes transmitting, by a user equipment (UE), a physical uplink control channel (PUCCH) to a base station, the UE being configured with an uplink (UL) subband, by: receiving, by the UE, a configuration for at least one PUCCH resource; determining, by the UE, whether a PUCCH resource is valid for the UL subband based on the configuration; and in response to the determining that the PUCCH resource is valid for the UL subband, transmitting, by the UE, the PUCCH in the PUCCH resource to the base station.

In one embodiment, the present disclosure describes a method for wireless communication. The method includes receiving, by a base station, a physical uplink control channel (PUCCH) from a user equipment (UE) by: configuring, by the base station, an uplink (UL) subband for the UE; sending, by the base station, a configuration for at least one PUCCH resource to the UE; determining, by the base station, whether a PUCCH resource is valid for the UL subband based on the configuration; and in response to the determining that the PUCCH resource is valid for the UL subband, receiving, by the base station, the PUCCH in the PUCCH resource from the UE.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows one exemplary configuration pattern of an uplink (UL) subband in the present disclosure.

FIG. 1C shows another exemplary configuration pattern of a UL subband in the present disclosure.

FIG. 1D shows another exemplary configuration pattern of a UL subband in the present disclosure.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5 shows a schematic diagram of an exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for configuring and scheduling a physical uplink control channel (PUCCH), particularly for a UL subband.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

In some existing wireless communication schemes, an uplink (UL) symbol or slot may be configured/scheduled to transmit data or control information from a user equipment to a base station; and a downlink (DL) symbol or slot may be configured/scheduled to transmit data or control information from the base station to the UE. In some existing schemes, UL symbols/slots are fewer and/or discontinuous in comparison to DL symbols/slots, resulting relatively poor performance in term of the timeliness and/or edge coverage of UL transmission, which may be due to no more consecutive UL symbols/slots.

For a non-limiting example, for a time division duplex (TDD) carrier, a DL symbol (or slot) and a UL symbol (or slot) are time-divisionally configured. Further, in some implementations, DL symbols/slots are configured more than UL symbols/slots.

In the present disclosure, the description of various embodiments/implementations may focus on the level of slots (or the level of symbols in some other various embodiments/implementations), which is not a limitation to the embodiment(s)/implementation(s) and the described embodiments/implementations may be applicable to both the level of slots and the level of symbols.

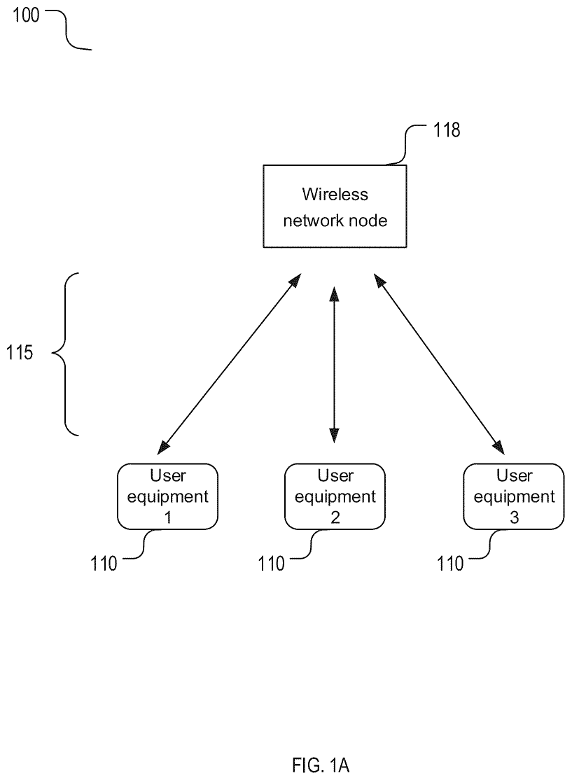

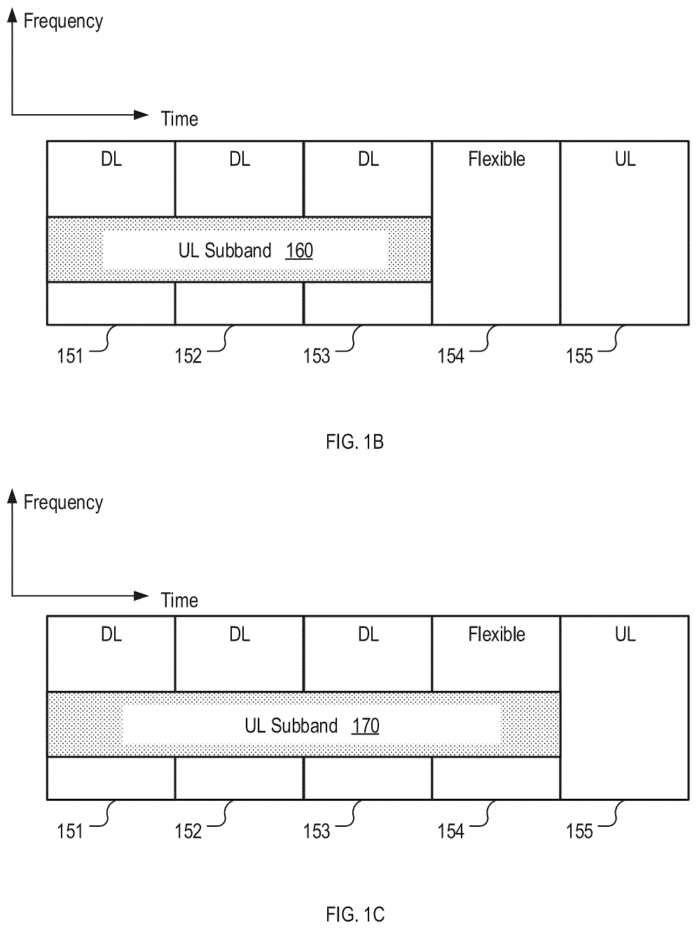

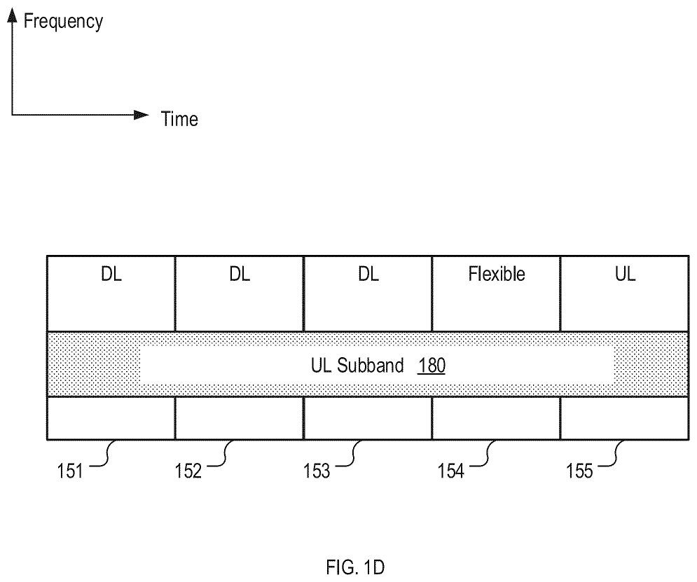

For a non-limiting example, referring to FIG. 1B, a typical symbol/slot structure is DDDSU (151, 152, 153, 154, and 155). Here, D represents a DL symbol/slot, U represents a UL symbol/slot, and S represents a flexible symbol/slot, which contains DL symbols and UL symbols. Obviously, UL slots are fewer and discontinuous, and these characteristics affect the performance of UL transmission. For example, due to no more consecutive or available UL slots, a large data volume of UL may not be supported, and/or more importantly, a timeliness and edge coverage of UL transmission may be relatively poor.

In some implementations, a full-duplex technology based on the UL subband may be implemented as subband full duplex (SBFD), wherein the configuration patterns of the UL subband may have the various types.

FIG. 1B shows one type of the configuration pattern of the UL subband, wherein a UL subband 160 is configured only in DL symbols/slots. In some implementations, the UL subbands may be configured in some or all DL symbols/slots.

FIG. 1C shows another type of the configuration pattern of the UL subband, wherein a UL subband 170 is configured in DL symbols/slots and flexible symbols/slots. In some implementations, the UL subbands may be configured in some or all of the DL symbols/slots and some or all of the flexible symbols/slots.

FIG. 1D shows another type of the configuration pattern of the UL subband,

wherein a UL subband 180 is configured in DL symbols/slots, flexible symbols/slots and UL symbols/slots. In some implementations, the UL subbands may be configured in some or all of the DL symbols/slots, some or all of the flexible symbols/slots, and some or all of the UL symbols/slots.

The various embodiments in the present disclosure illustrate that UL subbands can be configured in DL symbols/slots, flexible symbols/slots, or even UL symbols/slots. The symbols configured for the UL subband can also be referred to as subband full duplex symbols/slots (SBFD symbols/slots).

In some implementations, a UL subband may be configured to contain at least one DL symbol/slot.

In various embodiments, a UL subband may provide continuous UL resource from the DL symbols/slots, which is beneficial to expand UL resources, to reduce the delay of UL transmission, for example, by reducing the time waiting for UL opportunities, and/or to improve uplink coverage. The present disclosure describes various embodiments for enhancing the random access procedure based on the UL subband, thus improving the performance of random access in terms of capacity, delay and coverage.

In some implementations, a UE may be configured with up to 4 dedicated UL bandwidth parts (BWPs). In some implementations, always only one UL BWP may be activated. PUCCH resources may be configured per UL BWP. A corresponding index is configured for each configured PUCCH resource, and then a PUCCH resource is scheduled through the PUCCH index. In some implementations, in each indicated slot for transmitting PUCCH, all configured PUCCH resources may exist; and/or in the slot, a PUCCH resource is determined for transmission according to the indication (or configuration) signaling sent by a base station or according to a pre-agreed agreement between the base station and the UE.

In some implementations, when the UL subband is introduced, PUCCH may be able to be transmitted in the UL subband; and there remain some issues/problems of how to obtain the PUCCH resource for one UL subband. The present disclosure describes various embodiments for configuring and scheduling a physical uplink control channel (PUCCH) in a UL subband, addressing at least one of the issues/problems discussed above, improving performance of the wireless communication, particularly the performance of PUCCH resource configuration and/or PUCCH transmission.

FIG. 1A shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

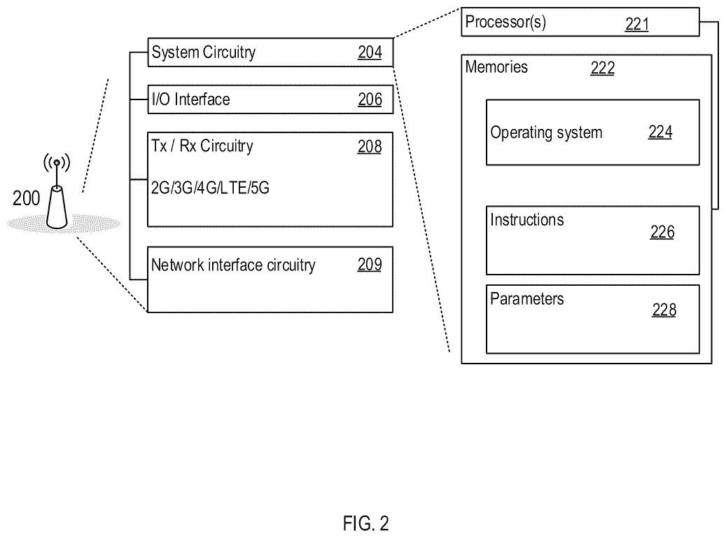

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

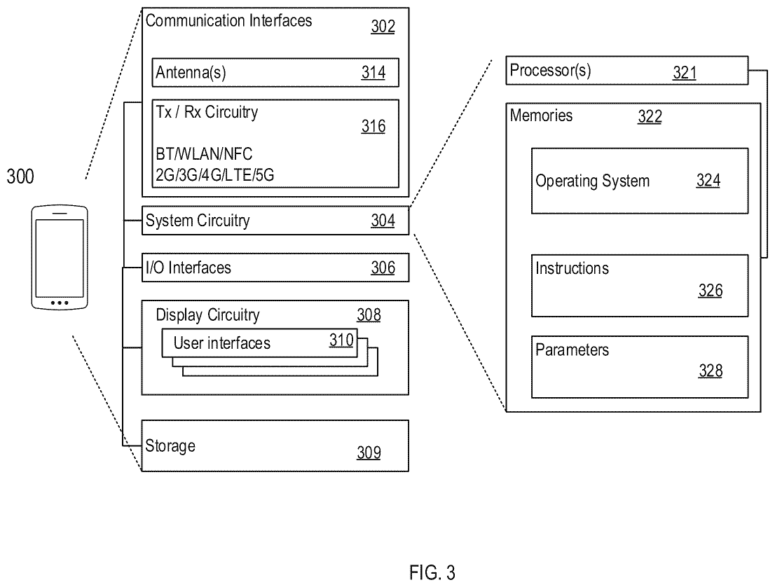

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA) +, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for configuring and scheduling a physical uplink control channel (PUCCH), particularly for a UL subband, which may be implemented, partly or totally, on the network base station and/or the user equipment described above in FIGS. 2-3.

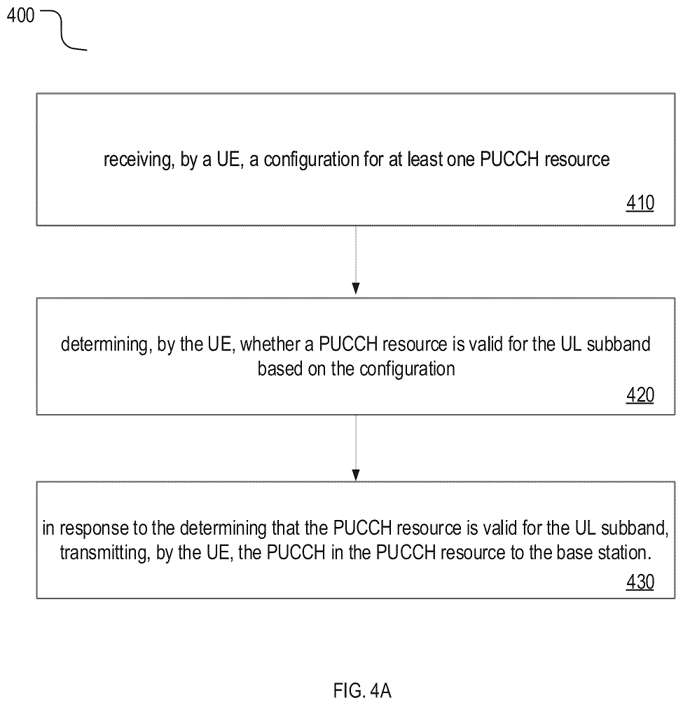

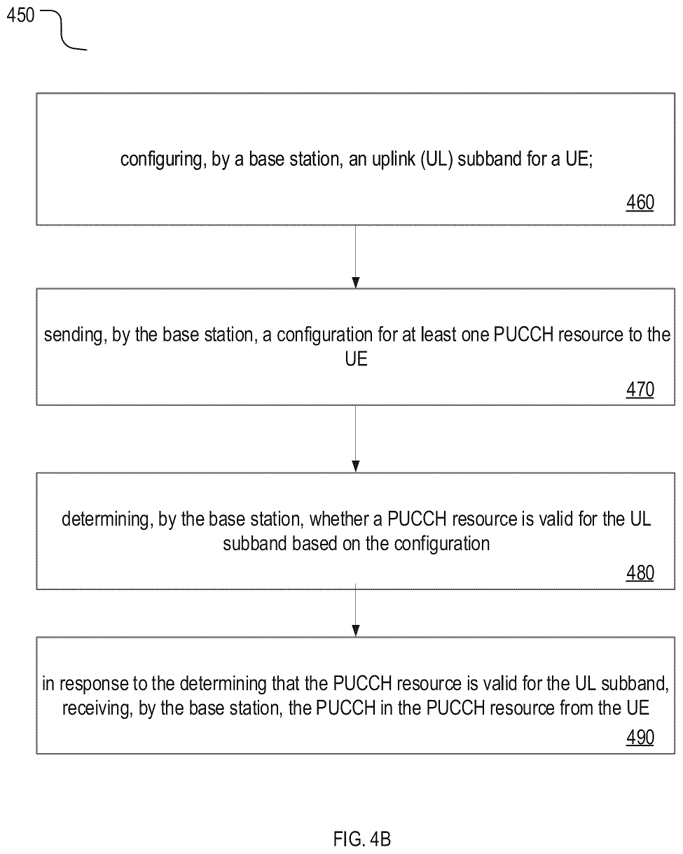

Referring to FIG. 4A, the present disclosure describes various embodiments of a method 400 for wireless communication including transmitting, by a user equipment (UE), a physical uplink control channel (PUCCH) to a base station, the UE being configured with an uplink (UL) subband. The method 400 may include a portion or all of the following steps: step 410, receiving, by the UE, a configuration for at least one PUCCH resource; step 420, determining, by the UE, whether a PUCCH resource is valid for the UL subband based on the configuration; and/or step 430, in response to the determining that the PUCCH resource is valid for the UL subband, transmitting, by the UE, the PUCCH in the PUCCH resource to the base station.

Referring to FIG. 4B, the present disclosure describes various embodiments of a method 450 for wireless communication including receiving, by a base station, a physical uplink control channel (PUCCH) from a user equipment (UE). The method 450 may include a portion or all of the following steps: step 460, configuring, by the base station, an uplink (UL) subband for the UE; step 470, sending, by the base station, a configuration for at least one PUCCH resource to the UE; step 480, determining, by the base station, whether a PUCCH resource is valid for the UL subband based on the configuration; and/or step 490, in response to the determining that the PUCCH resource is valid for the UL subband, receiving, by the base station, the PUCCH in the PUCCH resource from the UE.

In some implementations, in addition to a portion, an entire, or any combination of the described implementation(s)/embodiment(s), the method 450 may further include in response to the determining that the PUCCH resource is valid for the UL subband, scheduling, by the base station, the PUCCH in the PUCCH resource for the UL subband.

In some implementations, in addition to a portion, an entire, or any combination of the described implementation(s)/embodiment(s), the UE determines whether the PUCCH resource is valid for the UL subband based on at least one of the following: a set of predefined rules based on the configuration; or whether the PUCCH resource is scheduled by the base station to transmit in the UL subband.

In some implementations, in addition to a portion, an entire, or any combination of the described implementation(s)/embodiment(s), the base station determines whether the PUCCH resource is valid for the UL subband based on the set of predefined rules and the configuration.

In some implementations, in addition to a portion, an entire, or any combination of the described implementation(s)/embodiment(s), the set of predefined rules comprises that the PUCCH resource comprises at least one downlink (DL) symbol in a slot, and the UL subband comprises the at least one downlink (DL) symbol in the slot.

In some implementations, in addition to a portion, an entire, or any combination of the described implementation(s)/embodiment(s), the set of predefined rules in a slot comprises at least one of the following: when a time-frequency resource of the PUCCH resource is within a time-frequency resource of the UL subband, the PUCCH resource is determined to be valid for the UL subband; when a time resource of the PUCCH resource does not overlap with a time resource of a synchronization signal block (SSB) or a control resource set 0 (CORESET #0), the PUCCH resource is determined to be valid for the UL subband; when a frequency resource of the PUCCH resource is not within a frequency resource of the UL subband, the PUCCH resource is determined to be not valid for the UL subband; when a frequency resource of the PUCCH resource is not completely within a frequency resource of the UL subband, the PUCCH resource is determined to be not valid for the UL subband; when a time resource of the PUCCH resource is not within a time resource of the UL subband, the PUCCH resource is determined to be not valid for the UL subband; when a time resource of the PUCCH resource is not completely within a time resource of the UL subband, the PUCCH resource is determined to be not valid for the UL subband; when a time-frequency resource of the PUCCH resource is not within a time-frequency resource of the UL subband, the PUCCH resource is determined to be not valid for the UL subband; when a time-frequency resource of the PUCCH resource is not completely within a time-frequency resource of the UL subband, the PUCCH resource is determined to be not valid for the UL subband; or when a frequency resource of the PUCCH resource is within a frequency resource of the UL subband, one part of a time resource of the PUCCH resource is within a time resource of the UL subband, and a remaining part of the time resource of the PUCCH resource is within a time resource of a UL or flexible symbols, the PUCCH resource is determined to be valid for the UL subband; when a frequency resource of the PUCCH resource is within a frequency resource of the UL subband, one part of a time resource of the PUCCH resource is within a time resource of the UL subband, and a remaining part of the time resource of the PUCCH resource is within a time resource of at least one UL or flexible symbol, the PUCCH resource is determined to be not valid for the UL subband; and/or when a frequency resource of the PUCCH resource is within a frequency resource of the UL subband, one part of a time resource of the PUCCH resource is within a time resource of the UL subband, and a remaining part of the time resource of the PUCCH resource is within a time resource of at least one UL or flexible symbol, whether the PUCCH resource is determined to be valid based on a set of conditions. In some implementations, the UL or flexible symbols may not configured for the UL subband.

In some implementations, in addition to a portion, an entire, or any combination of the described implementation(s)/embodiment(s), the set of conditions comprises at least one of the following: a signaling configuration by the base station; a timing advance (TA) of the UL subband is same as a TA of the at least one UL or flexible symbol; symbols of the UL subband are contiguous with the at least one UL or flexible symbol in a time domain; symbols of the UL subband are contiguous with the at least one UL or flexible symbol in a time domain at least in a frequency domain of the UL subband; an end of a last symbol of the UL subband is contiguous with a start of a first symbol of the at least one UL or flexible symbol in a time domain; an end of a last symbol of the UL subband is contiguous with a start of a first symbol of the at least one UL or flexible symbol in a time domain at least in a frequency domain of the UL subband; the TA offset between the symbols of the UL subband and the at least one UL or flexible symbol is 0; the TA offset between the symbols of the UL subband and the at least one UL or flexible symbol is 0 at least in a frequency domain of the UL subband; the transmission in the UL subband and the transmission in the at least one UL or flexible symbol correspond to the same antenna panel; and/or the UL subband and the at least one UL or flexible symbol have the same subcarrier spacing (SCS).

In some implementations, in addition to a portion, an entire, or any combination of the described implementation(s)/embodiment(s), the at least one UL or flexible symbol corresponds to a UL bandwidth part (BWP) configured for the UE.

In some implementations, in addition to a portion, an entire, or any combination of the described implementation(s)/embodiment(s), the base station configures n PUCCH resources, and the UL subband shares the n PUCCH resources as PUCCH resources for the UL subband; and/or the base station configures m PUCCH resources for the UL subband based on their index of PUCCH resources from n PUCCH resources, wherein: m and n are positive integers, the UE is configured with at least one UL bandwidth part (BWP) and the UL subband, and/or the base station configures the n PUCCH resources per UL BWP.

In some implementations, in addition to a portion, an entire, or any combination of the described implementation(s)/embodiment(s), when a second PUCCH resource overlaps with the UL subband and at least one UL or flexible symbol corresponding to a UL BWP in the time domain, the base station is prohibited from scheduling the second PUCCH resource for the UE, wherein the UE is configured with the UL subband and the UL BWP.

In some implementations, in addition to a portion, an entire, or any combination of the described implementation(s)/embodiment(s), when a second PUCCH resource overlaps with the UL subband and at least one UL or flexible symbol corresponding to a UL BWP in the time domain, and the second PUCCH resource is scheduled for the UE by the base station, the UE perform at least one of the following: not transmitting the PUCCH on the second PUCCH resource; canceling the transmission of the PUCCH on the second PUCCH resource; and/or using a delay feedback mechanism for a hybrid automatic repeat request acknowledgement (HARQ-ACK) on the second PUCCH resource when the HARQ-ACK corresponds to a semi-persistent scheduling (SPS) physical downlink shared channel (PDSCH) and the SPS PDSCH is configured with the delay feedback mechanism.

In some implementations, in addition to a portion, an entire, or any combination of the described implementation(s)/embodiment(s), the UE is configured with the UL subband and a UL BWP; a second PUCCH resource spans at least one symbol of the UL subband and at least one UL or flexible symbol in the UL BWP; and/or in response to at least one condition in the set of conditions being satisfied, the second PUCCH resource is scheduled by the base station for the UE.

In some implementations, in addition to a portion, an entire, or any combination of the described implementation(s)/embodiment(s), the base station transmits downlink control information (DCI) to the UE, wherein the DCI comprises a parameter indicating whether an index in the DCI scheduling a PDSCH is based on the UL subband or based on a UL BWP.

In some implementations, in addition to a portion, an entire, or any combination of the described implementation(s)/embodiment(s), in response to the parameter indicating the index is based on the UL subband, an interval value between a PDSCH and its corresponding HARQ-ACK is obtained based on the index and a first configured interval set based on the UL subband; and/or in response to the parameter indicating the index is based on the UL BWP, the interval value between the PDSCH and its corresponding HARQ-ACK is obtained based on the index and a second configured interval set based on the UL BWP.

In some implementations, in addition to a portion, an entire, or any combination of the described implementation(s)/embodiment(s), a control resource set (CORESET) corresponding to the UL subband is configured to the UE; in response to a DCI being transmitted in the CORESET corresponding to the UL subband, an interval value between a PDSCH and its corresponding HARQ-ACK is obtained based on an index and a first configured interval set based on the UL subband, wherein the DCI schedules the PDSCH and comprises the index; in response to a DCI being transmitted outside of the CORESET corresponding to the UL subband, the interval value between the PDSCH and its corresponding HARQ-ACK is obtained based on an index and a second configured interval set based on the UL BWP; in response to a UL transmission being indicated by the DCI from the CORESET, parameters related to the UL transmission are determined based on the UL subband, and the UL transmission is performed in the UL subband, wherein the UL transmission comprises one of PUCCH, physical uplink shared channel (PUSCH), or physical random access channel (PRACH); and/or in response to the DCI from the CORESET indicating that a UL transmission is in the indicated downlink resource, the UL transmission is transmitted in the indicated downlink resource, wherein the UL transmission comprises one of PUCCH, PUSCH, or PRACH.

In some implementations, in addition to a portion, an entire, or any combination of the described implementation(s)/embodiment(s), a radio resource control (RRC) message comprises a power parameter in a UL BWP indicating a PUCCH power control in the UL BWP for the UE; and/or a power control of a PUCCH transmission in the UL subband is based on the power parameter in the UL BWP.

In some implementations, in addition to a portion, an entire, or any combination of the described implementation(s)/embodiment(s), the RRC message comprises a power-offset parameter for the UL subband, wherein the power-offset parameter indicates an adjustment of the power control of a PUCCH transmission in the UL subband in relative to a reference value based on the power parameter in the UL BWP.

In some implementations, in addition to a portion, an entire, or any combination of the described implementation(s)/embodiment(s), the power parameter is pucch-PowerControl; and/or a final PUCCH power in the UL subband is obtained by adding or decreasing an offset value based on the power-offset parameter based on the reference value based on the power parameter in the UL BWP.

In some implementations, in addition to a portion, an entire, or any combination of the described implementation(s)/embodiment(s), in response to the PUCCH resource comprising at least one symbol in the UL subband and at least one UL or flexible symbol in a UL BWP, a power control of transmitting the PUCCH is determined by at least one of the following: based on a power parameter corresponding to the UL subband; based on a power parameter corresponding to the UL BWP; based on whether a start symbol of the PUCCH is in the UL subband or in the UL BWP; based on, for each symbol of the PUCCH, whether the symbol is in the UL subband or in the UL BWP; and/or based on a first number of symbols in the UL subband and a second number of symbols in the UL BWP.

In some implementations, in addition to a portion, an entire, or any combination of the described implementation(s)/embodiment(s), the power control of transmitting the PUCCH is determined based on whether the start symbol of the PUCCH is in the UL subband or in the UL BWP by: in response to the start symbol of the PUCCH being in the UL subband, the power control of transmitting the PUCCH is determined based on the power parameter corresponding to the UL subband, and/or in response to the start symbol of the PUCCH being in the UL BWP, the power control of transmitting the PUCCH is determined based on the power parameter corresponding to the UL BWP; the power control of transmitting the PUCCH is determined based on, for each symbol of the PUCCH, whether the symbol is in the UL subband or in the UL BWP by: in response to the symbol being in the UL subband, the power control of transmitting the symbol is determined based on the power parameter corresponding to the UL subband, and/or in response to the symbol being in the UL BWP, the power control of transmitting the symbol is determined based on the power parameter corresponding to the UL BWP; and/or the power control of transmitting the PUCCH is determined based on the first number of symbols in the UL subband and the second number of symbols in the UL BWP by: in response to the first number being larger than or equal to the second number, the power control of transmitting the PUCCH is determined based on the power parameter corresponding to the UL subband, and/or in response to the first number being smaller than the second number, the power control of transmitting the PUCCH is determined based on the power parameter corresponding to the UL BWP.

In some implementations, in addition to a portion, an entire, or any combination of the described implementation(s)/embodiment(s), the base station configures a frequency-offset parameter for the UL subband to the UE, wherein the frequency-offset parameter indicates at least one of the following: a starting resource block (RB) of the UL subband relative to a starting RB of the UL BWP, and/or an ending RB of the UL subband relative to an ending RB of the UL BWP.

In some implementations, in addition to a portion, an entire, or any combination of the described implementation(s)/embodiment(s), the base station configures a pattern period in slot unit for the UL subband to the UE, one pattern period comprising one or more slots with at least one of the following: for all DL symbols in the one pattern period, a start symbol and an end symbol indicating symbols of the UL subband; for all DL symbols in the one pattern period, a start symbol and a number of symbols indicating the symbols of the UL subband; for all DL and flexible symbols in the one pattern period, a start symbol and an end symbol indicating symbols of the UL subband; and/or for all DL and flexible symbols in the one pattern period, a start symbol and a number of symbols indicating the symbols of the UL subband.

The present disclosure describes some specific non-limiting embodiments for for configuring and scheduling a physical uplink control channel (PUCCH), particularly for a UL subband.

### Embodiment 1

The present disclosure describes how a UE (or a base station) determines a validity of a PUCCH resource. In some implementations, for a configured UL subband, it may shares PUCCH resources configured for UL BWP. When a PUCCH is scheduled for transmission over the UL subband, the PUCCH may be valid based on the time-frequency resources of the UL subband. When the PUCCH is invalid, the UE does not transmit the PUCCH (or, the UE cancels the PUCCH).

In some implementations, based on the existing PUCCH resource allocation of per UL BWP, a series of PUCCH resources are obtained. Combined with the configured time-frequency resources of the UL subband, the base station determines the validity of the PUCCH resources for the UL subband from the series of PUCCH resources based on a predefined rule. The base station may schedule or receive the PUCCH transmission from the UL subband based on determined validity of the PUCCH resources (e.g., when it's determined the PUCCH resource is a valid PUCCH resource).

In some implementations, the UE may determine the validity of the PUCCH resources for the UL subband from the series of PUCCH resources based on a predefined rule, which may be the same as the predefined rule for the base station, or different. In some implementations, the UE may expect that when a PUCCH resource is scheduled to transmit in the UL subband, the PUCCH resource is valid for the UL subband. In some implementations, the UE does not expect an invalid PUCCH resource to be scheduled in the UL subband.

In some implementations, in a slot, when a configured PUCCH resource corresponds to one or more DL symbols, and the slot is configured with at least one UL subband in the one or more DL symbols or in the one or more DL symbols and flexible symbols, the base station and the UE respectively determine that the PUCCH resource is valid (or invalid) based on at least one or any combination of the following predefined rules.

One (predefined) rule includes that, when the time-frequency resource of a PUCCH resource is within the time-frequency resource range of the UL subband, the PUCCH resource can be considered valid for the UL subband.

Another (predefined) rule includes that, when a PUCCH resource does not overlap with SSB or Control Resource Set 0 (CORESET #0) in the time domain, the PUCCH resource can be valid for the UL subband.

Another (predefined) rule includes that, when the frequency domain resources of a PUCCH resource are not within the frequency domain resources of the UL subband, or the frequency domain resources of a PUCCH resource are not completely within the frequency domain resources of the UL subband, the PUCCH resource is not valid for the UL subband.

Another (predefined) rule includes that, when the time domain resource of a PUCCH resource is not within the time domain resource range of the UL subband, or the time domain resource of a PUCCH resource is not completely within the time domain resource range of the UL subband, the PUCCH resource is not valid for the UL subband.

Another (predefined) rule includes that, when the time-frequency resource of a PUCCH resource is not within the time-frequency resource range of the UL subband, or the time-frequency resource of a PUCCH resource is not completely within the time-frequency resource range of the UL subband, the PUCCH is not valid for the UL subband.

In some implementations, for a PUCCH resource, when its frequency domain resources are within the frequency domain range of the UL subband, and part of its time domain resources are within the time domain range of the UL subband, the remaining part of its time domain resources is within the (UL BWP corresponding) UL (or F) symbols, the validity of the PUCCH resource may be determined as one of the following: the PUCCH resource is valid for the UL subband; or the PUCCH resource is invalid for the UL subband; or the PUCCH resource is valid (or invalid) for the UL subband based on the signaling configuration/indication sent by the base station; or the PUCCH resource is valid (or invalid) based on another set of conditions. For a non-limiting example, when a PUCCH with a low code rate loses data in one symbol and the PUCCH may still be decoded correctly with a high probability, the base station may indicate that the PUCCH is valid.

In some implementations, another set of conditions may include at least one or any combination of the following: when the timing advance (TA) of the UL subband is the same as the timing advance of the (UL BWP corresponding) UL (or F) symbols; when the symbols of the UL subband are contiguous with the (UL BWP corresponding) UL (or F) symbols (at least in the frequency domain of the UL subband) in the time domain; when the end of the last symbol of the UL subband is contiguous with the start of the first symbol of the (UL BWP corresponding) UL (or F) symbol (at least in the UL subband frequency domain) in the time domain; when the TA offset between the symbols of the UL subband and the UL (or F) symbol is 0; when the transmission in the UL subband and the transmission in the UL BWP correspond to the same panel or device; or when the UL subband and UL BWP have the same SCS. For a non-limiting example, in TDD, the transmission in the UL subband and the transmission in the UL BWP are the same device, and all DL receptions are the same device. Likewise, the base station receives data from the UL subband and UL BWP based on the same device, and all DL transmissions are the same device. In this way, when the base station and the UE perform reception and transmission, the switching device can be avoided, so that a gap in the time domain may not be configured between the symbols (or DL symbols) of the UL subband and the UL symbols.

In some implementations, in a slot, when the above another set of conditions is satisfied, the base station and the UE may consider/determine that the PUCCH resource is valid; otherwise, the base station and the UE may consider/determine that the PUCCH resource is invalid.

In the above implementation(s)/embodiment(s), only one PUCCH resource configuration may be required. For a non-limiting example, the base station only configures some PUCCH resources for the UL BWP, and the UL subband shares these PUCCH resources based on the above method). It is easy to realize that the UL subband and the UL BWP share the PUCCH resource, which may make maintenance of PUCCH resources simple.

In some implementations, another configuration of PUCCH resources for UL subbands is described. For the UE configured with UL BWP and UL subband, the base station configures n dedicated PUCCH resources per the UL BWP through the PUCCH-config parameter, and assigns an index to each PUCCH resource, wherein n is a positive integer. The base station configures m PUCCH resources for the UL subband based on the index of the PUCCH resources from the n PUCCH resources, wherein m is a positive integer and/or m is smaller than or equal to n. For a non-limiting example, the base station configures the indices of m PUCCH resources for the UL subband from the indices of the n PUCCH resources. The base station and the UE respectively determine that the PUCCH resources corresponding to the m indices are for the UL subband. The m PUCCH resources may be within the frequency domain range of the UL subband. Since the symbols corresponding to the UL subband in each slot may be different, for the UL subband in a slot, whether the m PUCCH resources are valid (or invalid) still needs to be judged according to the method described in the above implementation.

Any portion or any combinations of the described implementations/embodiments in the present disclosure may also apply to PUSCH, for example, the PUCCH of the described implementations/embodiments in the present disclosure may be replaced by the PUSCH.

### Embodiment 2

The present disclosure describes how to schedule a PUCCH resource. In some implementations, in a TDD carrier for simplicity or low cost, there may be a time-domain gap between DL symbols and UL symbols, which is mainly used for transmission switching between DL and UL. The time domain gap can also be included in the timing advance. That is, in some implementations, there is no continuity in the time domain between DL symbols and UL symbols.

In some implementations, the following methods are described.

For one method, for a UE configured with UL subband and UL BWP, the UE does not expect to be scheduled a PUCCH that spans the symbols of the UL subband and the UL/F symbols of the UL BWP in the time domain. That is, all symbols of one PUCCH can only be scheduled within the UL subband or within the UL/F symbols of the UL BWP. This limitation can avoid the switching delay between the UL subband and the UL BWP, especially when the UL subband and UL BWP are not aligned in the frequency domain. In some implementations, correspondingly, the base station is prohibited from scheduling a PUCCH in a slot containing the UL subband and UL BWP for the UE configured with the UL subband and UL BWP, when the PUCCH spans the symbols of the UL subband and the UL/F symbols of the UL BWP in the time domain. In some implementations, in order to reduce the limitation of base station scheduling, when the above-mentioned PUCCH is scheduled for a UE configured with a UL subband, the UE does not perform the PUCCH transmission, and cancels the PUCCH transmission. In some implementations, the base station and the UE may agree that the delay feedback mechanism (in TS 38.213) can be used for the HARQ-ACK in the PUCCH if the HARQ-ACK corresponds to an SPS PDSCH and the SPS PDSCH is configured with the delay feedback mechanism. This method may be a simple method, so that it is easy to implement; and/or this method may not be very efficient.

For another method, at least one UL subband is configured in DL symbols and UL BWP is configured in UL/F symbols. In general, the UL subband and the UL BWP have the above-mentioned gap in the time domain. The gap may also be set to 0 by some necessary enhancements, such as introducing a panel for receiving or transmitting for the UL subband and UL BWP. Another panel is introduced for reception or transmission for DL BWP (or transmissions in DL symbols and transmissions in DL symbols where UL subbands are located).

In some implementations, compared with the previous method, the present method may include a set of conditions for the scheduling of the PUCCH. For a UE configured with UL subband and UL BWP, when the set of conditions is satisfied in the slot, the UE may be scheduled with a PUCCH that spans the symbols of the UL subband and the UL/F symbols of the UL BWP in the time domain.

In some implementations, the set of conditions may be similar to the (another) set of conditions as described above in Embodiment 1. The set of conditions may include at least one or any combination of the following: when the timing advance (TA) of the UL subband is the same as the timing advance of the (UL BWP corresponding) UL (or F) symbols; when the symbols of the UL subband are contiguous with the (UL BWP corresponding) UL (or F) symbols (at least in the frequency domain of the UL subband) in the time domain; when the end of the last symbol of the UL subband is contiguous with the start of the first symbol of the (UL BWP corresponding) UL (or F) symbol (at least in the UL subband frequency domain) in the time domain; when the TA offset between the symbols of the UL subband and the UL (or F) symbol is 0; when the transmission in the UL subband and the transmission in the UL BWP correspond to the same panel or device; or when the UL subband and UL BWP have the same SCS. For a non-limiting example, in TDD, the transmission in the UL subband and the transmission in the UL BWP are the same device, and all DL receptions are the same device. Likewise, the base station receives data from the UL subband and UL BWP based on the same device, and all DL transmissions are the same device. In this way, when the base station and the UE perform reception and transmission, the switching device can be avoided, so that a gap in the time domain may not be configured between the symbols (or DL symbols) of the UL subband and the UL symbols.

In some implementations, the base station and the UE may agree that, when the UL subband and the UL BWP satisfy the above set of conditions, the base station may allow scheduling a PUCCH that spans the symbols of the UL subband and the symbols of the UL BWP. The UE may also make a decision for the PUCCH based on the above conditions.

In some implementations, when the above conditions are met, the UE may perform the transmission of the PUCCH, otherwise the UE does not perform the transmission of the PUCCH (and/or the UE cancels the PUCCH).

Any portion or any combinations of the described implementations/embodiments in the present disclosure may also apply to PUSCH, for example, the PUCCH of the described implementations/embodiments in the present disclosure may be replaced by the PUSCH.

### Embodiment 3

The present disclosure describes various configuration of the interval (parameter k1) between a PDSCH and its corresponding HARQ-ACK.

In some implementations, when the PUCCH resource is configured for the UE, the parameter kl set is also configured at the same time. The value of kl describes the number of slot intervals between a PDSCH and the corresponding HARQ-ACK. Generally, an index (describing the order of the k1 value in the k1 set) is included in the DCI (in the PDCCH) that schedules the PDSCH, and a k1 value can be obtained from the configured k1 set according to the index. For a non-limiting example, when a PDSCH is scheduled in slot n, the slot where its HARQ-ACK is located is slot n+k1. In the present disclosure, n and k1 are non-negative integers.

In some implementations, when the UL subband and the UL BWP are respectively configured with k1 sets, the UE needs to identify whether the index in the DCI scheduling a PDSCH is based on the UL subband or based on the UL BWP, in order to determine the slot for transmitting the HARQ-ACK corresponding to the PDSCH. The reason for this is that, because of the existence of different k1 sets, the indexes in DCI may get different k1 values from different k1 sets.

In some implementations, various methods are described below to identify whether the index of the k1 value in the DCI is based on UL subband or UL BWP.

One method includes introducing a new parameter in DCI. This (new) parameter in the DCI indicates that the index of the k1 value in the DCI is UL subband based or UL BWP based. Through this parameter, the base station and the UE can respectively determine the slot position for transmitting the HARQ-ACK of the PDSCH scheduled by the DCI. This parameter can also be used to identify whether the UL transmission associated with the DCI is scheduled based on the UL subband or the UL BWP. For example, through different values of this parameter, it respectively indicates that a UL transmission is based on the UL subband, or indicates that a UL transmission is based on UL BWP.

Another method includes configuring a control resource set (CORESET) and/or search space corresponding to the UL subband. When a PDCCH is received from the CORESET and/or search space, the index of the k1 value in the DCI in the PDCCH is based on the k1 set corresponding to the UL subband. Thus, for the base station, when a DCI schedules a PDSCH and wants its HARQ-ACK to be transmitted in the UL subband, the DCI should be transmitted in the CORESET and/or search space corresponding to the UL subband. When the UE receives a DCI in the PDCCH from the CORESET and/or search space corresponding to the UL subband, the UE considers that the index of the k1 value in the DCI is based on the k1 set of the UL subband, otherwise, the index of the k1 value in the DCI is based on the k1 set of UL BWP.

The method of configuring the corresponding CORESET and/or search space for a UL subband has the following benefits. When the base station uses a DCI to schedule a PUSCH in the PDCCH in the CORESET and/or search space, the base station expects the PUSCH to be transmitted based on one of the configuration information such as PUSCH resource allocation, power control, DMRS, and MCS tables corresponding to the UL subband. When a UE with UL subband capability receives a DCI scheduling PUSCH in the PDCCH in the CORESET and/or search space, the PUSCH is transmitted based on one of the configuration information such as PUSCH resource allocation, power control, DMRS, and MCS tables corresponding to the UL subband.

For a non-limiting example, the base station configures an independent CORESET and/or search space for the UE. The CORESET and/or search space may have the following functions.

In some implementations, when a UL subband is configured, a CORESET and/or search space may be configured and associated with the UL subband. When a DCI in the PDCCH is received from the CORESET and/or search space, and when the DCI schedules an UL transmission, the UE expects the UL transmission to be performed in the UL subband. Correspondingly, the parameters used to determine the UL transmission are from parameters configured for the UL subband. The UL transmission may include at least one of the following: PUCCH, PUSCH, and PRACH. When a DCI in the PDCCH is received from the CORESET and/or search space, and when the DCI schedules a DL transmission, the UE expects the HARQ-ACK PUCCH corresponding to the DL transmission to be performed in the UL subband. Correspondingly, the parameters used to determine the HARQ-ACK PUCCH transmission (e.g., k1 and/or power control) are from parameters configured for the UL subband. DL transmission may include at least one of the following: PDSCH and PDCCH for which HARQ-ACK needs to be fed back. Both the base station and the UE may follow should the above principles.

In some implementations, a separate CORESET and/or search space is configured for the UE, when the UL subband is configured. The CORESET and/or search space may have the following properties. The CORESET and/or search space is associated with subband full duplex operation. When a DCI in the PDCCH is received from the CORESET and/or search space, and the DCI schedules a UL transmission, and the UL transmission is allocated resources in the opposite direction to the UL transmission (e.g., the resources of the UL transmission contain DL symbols), the UE performs the UL transmission in the allocated resources. The UL transmission may include at least one of the following: PUCCH, PUSCH, and PRACH. When a DCI in the PDCCH is received from the CORESET and/or search space, and the DCI schedules a DL transmission, and the HARQ-ACK PUCCH transmission corresponding to the DL transmission is instructed to transmit in the DL symbol, the UE directly performs the HARQ-ACK PUCCH is transmitted in the DL symbol. Both the base station and the UE should follow by the above principles.

In some implementations, for a UE that supports subband full duplex operation, when a DCI is received from the CORESET and/or search space, it may know that the transmission scheduled by the DCI is related to the parameters and resources corresponding to the subband full duplex. This may not cause the DCI format to change, and may avoid extra overhead in the current DCI format.

In some implementations, configuring independent k1 sets for the UL subband and the UL BWP may provide scheduling flexibility. Configuring an independent CORESET and/or search space for the UL subband is beneficial to independent scheduling of UEs with UL subband capability, and does not affect the reception of PDCCH by legacy UEs. Configuring the corresponding PUSCH resource allocation, power control, DMRS or MCS tables for the UL subband is beneficial to better adapt to the data transmission in the UL subband, because the interference is different between the UL subband and the UL BWP.

In some implementations, another way may include the configuration of the k1 set. The UL subband may be configured to share the k1 set with the UL BWP. For a non-limiting example, when a transmission in the UL subband, it shares the k1 set configured in the UL BWP.

In some implementations, the base station configures a UL subband for the UE, and agrees with the UE that when a DCI schedules a transmission in the UL subband, the index of the k1 value in the DCI corresponds to the k1 set configured for the UL BWP.

In some implementations, similarly, for a PUSCH transmission scheduled in the UL subband, the PUSCH resource allocation, power control, DMRS or MCS tables configured for the UL BWP may also be shared. The base station and the UE may agree that when a DCI schedules a PUSCH in the UL subband, the PUSCH is transmitted based on the PUSCH resource allocation, power control, DMRS or MCS tables configured for the UL BWP.

### Embodiment 4

The present disclosure describes various implementations for power control of PUCCH in UL subband. In some implementations, the power control of the PUCCH is configured through the RRC parameter (e.g., pucch-PowerControl) per UL BWP, which is a UE-specific parameter and is PUCCH power control. It is optional to configure.

For one method, an existing parameter (e.g., pucch-PowerControl) is per UL BWP, which also applies to PUCCH transmitted in the UL subband. That is, the PUCCH transmitted in the UL subband shares the power control parameters configured for PUCCH transmission in the UL BWP, which is beneficial to reduce signaling overhead.

For a non-limiting example, the base station and the UE agree that the power control of the PUCCH transmitted in the UL subband is based on the parameter pucch-PowerControl in the UL BWP. In this way, there may be no need to independently configure the PUCCH power control parameters for the UL subband.

Additional conditions may also be considered. For a non-limiting example, when the frequency domain range of a UL subband is configured within the frequency domain range (size and location) of the UL BWP, the base station and the UE may agree that the power control of the PUCCH transmitted in the UL subband is based on the parameter pucch-PowerControl in the UL BWP.

For another non-limiting example, the PUCCH in the UL subband and the PUCCH in the UL BWP may share the same power control parameter based on the parameter pucch-PowerControl. However, considering that there is greater interference from DL transmission in the UL subband, it may be considered to add a parameter offset to adjust the PUCCH transmission power in the UL subband. For example, the base station and the UE agree that for the power control of the PUCCH in the UL subband, a reference value is obtained from the parameter pucch-PowerControl corresponding to the UL BWP, and then an offset is added/decreased based on the reference value to obtain the final PUCCH power.

In some implementations, the offset may be a value or a set of values that can be configured by the base station or determined by the UE based on measurements in the symbol where the UL subband is located. It may also be a predefined value. When the UE receives a DCI from a CORESET and/or search space that is configured and associated with UL subband full duplex operation, and when the DCI schedules a transmission in the UL subband or in the DL symbols, the offset may be used for the transmission.

For another method, when the UE is configured with a UL subband, a separate parameter (e.g., pucch-PowerControl) is configured for PUCCH power control in the UL subband. In some implementations, under this method, there are some fallback operations as follows.

For one example, when the UE is configured with pucch-PowerControl for the UL BWP, but not configured with pucch-PowerControl for the UL subband, the base station and the UE may agree that: the UE uses the pucch-PowerControl parameter for the UL BWP to perform power control of the PUCCH in the UL subband.

For another example, when the UE is not configured with pucch-PowerControl for the UL BWP, but is configured with pucch-PowerControl for the UL subband, the base station and the UE may agree that: the UE uses the pucch-PowerControl parameter for the UL subband to perform power control of the PUCCH in the UL BWP.

In some implementations, PUCCH power control for a PUCCH across the symbols of the UL subband and UL/F (corresponding to UL BWP) symbols is described below. For a PUCCH, when its time domain resources include symbols in the UL subband and UL/F (corresponding to UL BWP) symbols, its power control is based on one or a combination of the following.

Performing the power control of the PUCCH is based on the PUCCH power control parameter corresponding to the UL subband.

Performing the power control of the PUCCH is based on the PUCCH power control parameter corresponding to the UL BWP.

Determining the power control of the PUCCH based on the start symbol of the PUCCH. For one example, when the start symbol of the PUCCH is in the UL subband, the power control of the PUCCH is performed based on the PUCCH power control parameter corresponding to the UL subband. For another example, when the start symbol of the PUCCH is in the UL BWP, the power control of the PUCCH is performed based on the PUCCH power control parameter corresponding to the UL BWP.

The PUCCH symbols in the UL subband and symbols in the UL BWP are performed based on the PUCCH power control parameters configured in the UL subband and the UL BWP, respectively.

Determining the power control of the PUCCH is based on the number of symbols. For example, when the number of the PUCCH symbols in the UL subband is greater than or equal to the number of the PUCCH symbols in the UL BWP, the PUCCH power control is performed based on the PUCCH power control parameters corresponding to the UL subband; otherwise, based on the PUCCH power control parameters corresponding to the UL BWP.

Any portion or any combinations of the described implementations/embodiments in the present disclosure may also apply to PUSCH, for example, the PUCCH of the described implementations/embodiments in the present disclosure may be replaced by the PUSCH.

### Embodiment 5

The present disclosure describes various implementations of frequency domain resource configurations for one UL subband.

In some implementations, an offset parameter (parameter 1) may be introduced to describe the starting resource block (RB) of a UL subband based on the starting RB of the configured UL BWP in the frequency domain. Parameter 1 may be a positive value or a negative value, respectively corresponding to the offset direction of the starting RB of the UL subband relative to the starting RB of the UL BWP. For example, a positive value corresponds to the starting RB index of the UL subband that is smaller than the starting RB index of the UL BWP, and a negative value corresponds to the starting RB index of the UL subband that is greater than the starting RB index of the UL BWP.

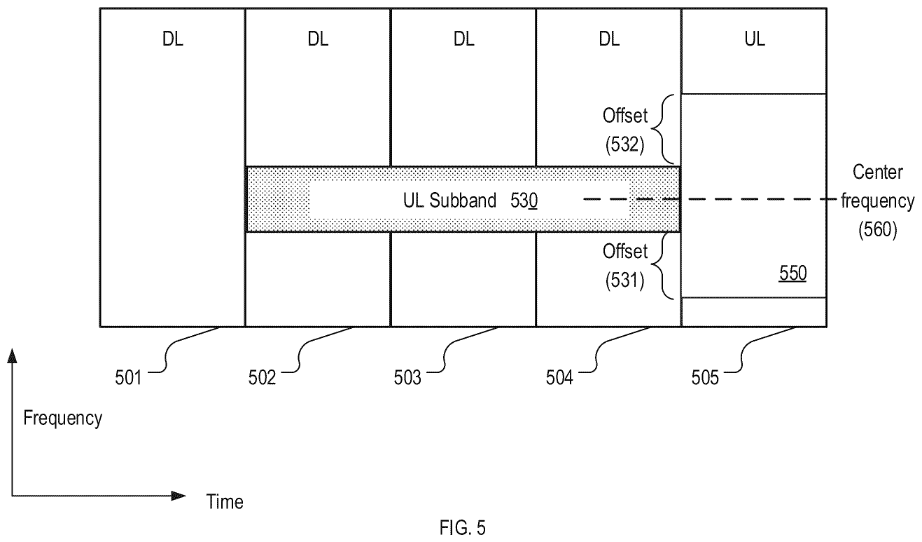

FIG. 5 shows one example, wherein a DL symbol/slot (501), a DL symbol/slot (502), a DL symbol/slot (503), a DL symbol/slot (504), and a UL symbol/slot (505) are configured. A UL subband (530) is configured for the UE in three DL symbols/slots (502, 503, and 504). A UL BWP (or an initial UL BWP) (550) may be configured. An offset (531) may correspond to a value of parameter 1, indicating an offset of the starting RB of a UL subband based on the starting RB of the configured UL BWP in the frequency domain.

In some implementations, optionally, the offset indicated by this parameter 1 is also used to define the end RB of the UL subband relative to the end RB of the UL BWP. An offset (532) may correspond to a value of parameter 1, indicating an offset of the end RB of a UL subband relative to the end RB of the configured UL BWP in the frequency domain. In this way, it is beneficial for the UL subband to be consistent with a center frequency (560) of the UL BWP.

For a non-limiting example, the start RB and the end RB of the UL BWP are: RB n and RB m, respectively, wherein n and m are non-negative integers. When the value of the parameter 1 is +20, the index of the starting RB of the UL subband is: RB n+20. Optionally, the index of the ending RB of the UL subband is: RB m−20. For example, when the value of this parameter 1 is −20, the index of the starting RB of the UL subband is: RB n−20. Optionally, the index of the ending RB of the UL subband is: RB m+20.

Based on the above method to configure frequency domain resources for a UL subband, the base station and the UE agree to determine the frequency domain resources of the UL subband in combination with the configured frequency domain resources of the UL BWP and parameter 1. At the same time, the UL subband also shares the SCS and Cyclic Prefix (CP) configured for the UL BWP configuration.

In some implementations, based on the above method, it may be easy to realize that the center frequency points of the configured UL subband and the configured UL BWP are consistent.

In some implementations, for a UL subband, the resource configuration in the time domain is described below. For a DL slot (all its symbols are DL symbols) and/or an S slot (which contains flexible symbols), one of the following methods may be implemented.

Bitmap signaling is employed to describe which symbols are configured with or without UL subbands based on the slot.

Through the start symbol and the end symbol (or the number of consecutive symbols) 2 parameters per slot to describe which symbols are configured or not configured for the UL subband. This description applies to all DL slots or slots containing F symbols. For a slot containing UL symbols, based on the description, if a UL symbol is configured with the UL subband, it is assumed that the UL symbol is not configured with the UL subband. That is, the description is invalid for UL symbols. In order to save signaling, the start symbol may be omitted and default to symbol 0 or default to the first symbol after the end symbol of PDCCH or CORESET.

For a slot, all remaining DL symbols and flexible symbols are configured with this UL subband by default, except for symbols of PDCCH or CORESET.

Some implementations include configuring a pattern period in slot units. For all DL symbols and/or F symbols in the one pattern period, the symbols for a UL subband are described by a start symbol and an end symbol (or number of symbols). For example, a pattern period is configured to contain n slots, and all DL symbols and/or F symbols in the n slots constitute a set of symbols based on the time positions of these symbols. The symbols that are configured (or not configured) for the UL subband are described from the set of symbols by a start symbol and an end symbol (or number of symbols). Alternatively, in order to save signaling, the first DL symbol or F symbol in the symbol set is used as the start symbol by default, but the end symbol (or the number of symbols) is described. Here, the start symbol may be the first DL or F symbol other than the symbol of PDCCH or CORESET. Here, among these determined symbols from the set of symbols, the symbols occupied by PDCCH or CORESET can be removed by default. Alternatively, among these determined symbols from the set of symbols, symbols occupied by PDCCH or CORESET can be signaled to be removed or reserved by the base station.

For a non-limiting example, for the symbols where the PDCCH or CORESET is located, the base station may indicate to the UE through signaling whether these symbols are configured as the UL subband. In the case where the symbols where the PDCCH or CORESET is located are configured for the UL subband, when the UE is scheduled or configured to perform UL transmission in symbols where the PDCCH or CORESET is located, the base station may instruct the UE through signaling to perform (or not perform) rate matching in RB (or symbol) units for the PDCCH or CORESET.

The present disclosure describes methods, apparatus, and computer-readable medium for wireless communication. The present disclosure addressed the issues with configuring and scheduling a physical uplink control channel (PUCCH), particularly for a UL subband. The methods, devices, and computer-readable medium described in the present disclosure may facilitate the performance of wireless communication by configuring and scheduling PUCCH, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
transmitting, by a user equipment (UE), a physical uplink control channel (PUCCH) to a base station, the UE being configured with an uplink (UL) subband, by:
receiving, by the UE, a configuration for at least one PUCCH resource;
determining, by the UE, whether a PUCCH resource is valid for the UL subband based on the configuration; and
in response to the determining that the PUCCH resource is valid for the UL subband, transmitting, by the UE, the PUCCH in the PUCCH resource to the base station.

2. A method for wireless communication, comprising:
receiving, by a base station, a physical uplink control channel (PUCCH) from a user equipment (UE) by:
configuring, by the base station, an uplink (UL) subband for the UE;
sending, by the base station, a configuration for at least one PUCCH resource to the UE;
determining, by the base station, whether a PUCCH resource is valid for the UL subband based on the configuration; and
in response to the determining that the PUCCH resource is valid for the UL subband, receiving, by the base station, the PUCCH in the PUCCH resource from the UE.

3. The method according to claim 2, further comprising:
in response to the determining that the PUCCH resource is valid for the UL subband, scheduling, by the base station, the PUCCH in the PUCCH resource for the UL subband.

4. The method according to claim 1, further comprising:
determining, by the UE, whether the PUCCH resource is valid for the UL subband based on at least one of the following:
a set of predefined rules based on the configuration; or whether the PUCCH resource is scheduled by the base station to transmit in the UL subband.

5. The method according to claim 2, further comprising:
determining, by the base station, whether the PUCCH resource is valid for the UL subband based on a set of predefined rules and the configuration.

6. The method according to claim 5, wherein:
the set of predefined rules comprises that the PUCCH resource comprises at least one downlink (DL) symbol in a slot, and the UL subband comprises the at least one downlink (DL) symbol in the slot.

7-9. (canceled)

10. The method according to claim 2, further comprising:
configuring, by the base station, n PUCCH resources, wherein the UL subband shares the n PUCCH resources as PUCCH resources for the UL subband; or
configuring, by the base station, m PUCCH resources for the UL subband based on their index of PUCCH resources from n PUCCH resources, wherein:
m and n are positive integers,
the UE is configured with at least one UL bandwidth part (BWP) and the UL subband, and
the base station configures the n PUCCH resources per UL BWP.

11. (canceled)

12. The method according to claim 1, further comprising:
when a second PUCCH resource overlaps with the UL subband and at least one UL or flexible symbol corresponding to a UL BWP in the time domain, and the second PUCCH resource is scheduled for the UE by the base station, performing, by the UE, at least one of the following:
not transmitting the PUCCH on the second PUCCH resource;
canceling the transmission of the PUCCH on the second PUCCH resource; or
using a delay feedback mechanism for a hybrid automatic repeat request acknowledgement (HARQ-ACK) on the second PUCCH resource when the HARQ-ACK corresponds to a semi-persistent scheduling (SPS) physical downlink shared channel (PDSCH) and the SPS PDSCH is configured with the delay feedback mechanism.

13. The method according to claim 1, wherein:
the UE is configured with the UL subband and a UL BWP;
a second PUCCH resource spans at least one symbol of the UL subband and at least one UL or flexible symbol in the UL BWP; and
in response to at least one condition in a set of conditions being satisfied, the second PUCCH resource is scheduled by the base station for the UE.

14. The method according to claim 2, further comprising:
transmitting, by the base station, downlink control information (DCI) to the UE, wherein the DCI comprises a parameter indicating whether an index in the DCI scheduling a PDSCH is based on the UL subband or based on a UL BWP.

15. The method according to claim 14, wherein:
in response to the parameter indicating the index is based on the UL subband, an interval value between a PDSCH and its corresponding HARQ-ACK is obtained based on the index and a first configured interval set based on the UL subband; or
in response to the parameter indicating the index is based on the UL BWP, the interval value between the PDSCH and its corresponding HARQ-ACK is obtained based on the index and a second configured interval set based on the UL BWP.

16-25. (canceled)

26. The method according to claim 4, wherein:
the set of predefined rules comprises that the PUCCH resource comprises at least one downlink (DL) symbol in a slot, and the UL subband comprises the at least one downlink (DL) symbol in the slot.

27. The method according to claim 2, wherein:
the UE is configured with the UL subband and a UL BWP;
a second PUCCH resource spans at least one symbol of the UL subband and at least one UL or flexible symbol in the UL BWP; and
in response to at least one condition in a set of conditions being satisfied, the second PUCCH resource is scheduled by the base station for the UE.

28. The method according to claim 1, further comprising:
receiving, by UE, downlink control information (DCI) from the base station, wherein the DCI comprises a parameter indicating whether an index in the DCI scheduling a PDSCH is based on the UL subband or based on a UL BWP.

29. The method according to claim 28, wherein:
in response to the parameter indicating the index is based on the UL subband, an interval value between a PDSCH and its corresponding HARQ-ACK is obtained based on the index and a first configured interval set based on the UL subband; or
in response to the parameter indicating the index is based on the UL BWP, the interval value between the PDSCH and its corresponding HARQ-ACK is obtained based on the index and a second configured interval set based on the UL BWP.

30. An apparatus comprising:
a memory storing instructions; and
at least one processor in communication with the memory, wherein, when the at least one processor executes the instructions, the at least one processor is configured to cause the apparatus to perform:
transmitting a physical uplink control channel (PUCCH) to a base station, the apparatus being configured with an uplink (UL) subband, by:
receiving a configuration for at least one PUCCH resource;
determining whether a PUCCH resource is valid for the UL subband based on the configuration; and
in response to the determining that the PUCCH resource is valid for the UL subband, transmitting the PUCCH in the PUCCH resource to the base station.

31. The apparatus according to claim 30, wherein, when the at least one processor executes the instructions, the at least one processor is configured to further cause the apparatus to perform:
determining whether the PUCCH resource is valid for the UL subband based on at least one of the following:
a set of predefined rules based on the configuration; or
whether the PUCCH resource is scheduled by the base station to transmit in the UL subband.

32. The apparatus according to claim 31, wherein:
the set of predefined rules comprises that the PUCCH resource comprises at least one downlink (DL) symbol in a slot, and the UL subband comprises the at least one downlink (DL) symbol in the slot.

33. An apparatus comprising:
a memory storing instructions; and
at least one processor in communication with the memory, wherein, when the at least one processor executes the instructions, the at least one processor is configured to cause the apparatus to perform:
receiving a physical uplink control channel (PUCCH) from a user equipment (UE) by:
configuring an uplink (UL) subband for the UE;
sending a configuration for at least one PUCCH resource to the UE;
determining whether a PUCCH resource is valid for the UL subband based on the configuration; and
in response to the determining that the PUCCH resource is valid for the UL subband, receiving the PUCCH in the PUCCH resource from the UE.

34. The apparatus according to claim 33, wherein, when the at least one processor executes the instructions, the at least one processor is configured to further cause the apparatus to perform:
in response to the determining that the PUCCH resource is valid for the UL subband, scheduling the PUCCH in the PUCCH resource for the UL subband.
